(19) United States
(12) Patent Application Publication
(10) Pub. No.: US 2017/0349007 A1
(43) Pub. Date: Dec. 7, 2017

(54) OPTICAL-BASED TREAD DEPTH MEASURING DEVICE, SYSTEM, AND METHOD

(71) Applicant: Bridgestone Americas Tire Operations, LLC, Nashville, TN (US)

(72) Inventor: Terence E. WEI, Copley, OH (US)

(73) Assignee: Bridgestone Americas Tire Operations, LLC, Nashville, TN (US)

(21) Appl. No.: 15/535,634

(22) PCT Filed: Oct. 22, 2015
(86) PCT No.: PCT/US2015/056813

§ 371 Date: Jun. 13, 2017

Related U.S. Application Data
(60) Provisional application No. 62/092,346, filed on Dec. 16, 2014.

(51) Int. Cl. B60C 11/24; G01M 17/02

(52) U.S. Cl. CPC B60C 11/246; G01M 17/027

(57) ABSTRACT

A device, system, and method for optically measuring the tread depth of a tire mounted on a vehicle, wherein at least one of a camera, a processor, and an onboard computer may be configured to determine the tread depth from images of the tire tread. Tread depth may be measured when the vehicle is either stationary or moving. Tread depth may be measured either manually by a vehicle operator or automatically by the optical-based tread depth measuring system.

### BACKGROUND

As a vehicle, such as an automobile (including a truck, a bus, and the like), is driven, its tires may begin to wear. As a result, a vehicle operator may need to either periodically check or continuously monitor for tire wear to determine when it may be appropriate to replace worn tires. Tire wear may be checked by a person using a ruler or similar measuring device while standing near a tire of a stationary vehicle. However, some operators may simply forget to check tire wear, or may simply find it too inconvenient, and in either event, do not check wear.

It may be desirable to check or monitor one or more tires on a vehicle for tire wear while the vehicle operator remains in the vehicle. It may be desirable to check or monitor for tire wear while the vehicle is in operation, such as when the vehicle is moving. What is needed is a device, system, and method to automatically and/or conveniently check tire wear.

### SUMMARY

In one embodiment, a tire tread depth measuring device may have: at least one camera configured to capture images of a tire tread surface, and at least one processor operatively connected to the camera, wherein the processor is configured to receive, interpret, and transmit a signal from the camera and determine a depth measurement of the tire tread surface. The camera may be at least one of: a digital camera, a video camera, a thermographic camera, an ultraviolet camera, and a radiographic camera. Two cameras may be configured to capture stereographic images. The tire tread depth measuring device may have at least one of: a wireless transmitter, a wireless receiver, and a wireless transceiver. The processor and the camera may be operatively interconnected by at least one of: a wire, a circuit trace, and a wireless transmission. The camera and the processor may be operatively connected to a vehicle. At least one of the camera and the processor may be operatively connected to the vehicle by at least one of: a bolt, a screw, a nut, a bracket, a hook, a weld, a magnet, and an adhesive.

In one embodiment, a tire tread depth measuring system may have: a vehicle having an onboard computer; at least one tire having a tread surface, wherein the at least one tire may be mounted to the vehicle; at least one camera, wherein the at least one camera may be oriented to have an unobstructed line of sight to the tire tread surface; and at least one processor operatively connected to at least one of the camera and the onboard computer, wherein the processor may be configured to receive and interpret a signal from the camera, determine a depth measurement of the tread surface, and transmit the depth measurement to the onboard computer. The tire tread depth measuring system may have a camera protection device, wherein the camera protection device may be configured to at least one of clean and protect the camera, wherein the camera protection device may have at least one of: a shield, a cover, a wiper, a screen, a film, a fluid, a reservoir, a pressurization device, and a nozzle. The camera may be at least one of: a digital camera, a video camera, a thermographic camera, an ultraviolet camera, and a radiographic camera. Two cameras may be configured to capture stereographic images. The tire tread depth measuring system may have at least one of: a wireless transmitter, a wireless receiver, and a wireless transceiver. At least one of the camera, the processor, and the onboard computer may be operatively interconnected by at least one of: a wire, a circuit trace, and a wireless transmission. At least one of the camera and the processor may be operatively connected to a vehicle. At least one of the camera and the processor may be operatively connected to the vehicle by at least one of: a bolt, a screw, a nut, a bracket, a hook, a weld, a magnet, and an adhesive.

In one embodiment, a tire tread depth measuring method may include: capturing at least one image of a tread surface, determining from the image at least two reference tread surface points, wherein at least one of the reference tread surface points may be oriented on a high tread portion, wherein at least one of the reference tread surface points may be oriented on a low tread portion, and measuring a difference in tread depth between the reference tread surface points. The tire tread depth measuring method may be performed on either a stationary vehicle or a moving vehicle. The tire tread depth measuring method may be initiated either manually by a vehicle operator or automatically by at least one of: a camera, a processor, and an onboard vehicle computer.

### BRIEF DESCRIPTION OF THE DRAWINGS

The accompanying figures, which are incorporated in and constitute a part of the specification, illustrate various example devices, systems, and methods, and are used merely to illustrate various example embodiments. In the figures, like elements bear like reference numerals.

FIG. 1A illustrates an elevation view of an example arrangement of an optical-based tread depth measuring device and system.

FIG. 1B illustrates a sectional view of an example arrangement of an optical-based tread depth measuring device and system.

FIG. 1C illustrates a sectional view of an example arrangement of an optical-based tread depth measuring device and system.

FIG. 1D illustrates a schematic of an optical-based tread depth measuring device and system.

FIG. 2 illustrates an elevation view of an example arrangement of an optical-based tread depth measuring device and system.

FIG. 3 illustrates an elevation view of an example arrangement of an optical-based tread depth measuring device and system.

FIG. 4 illustrates an elevation view of an example arrangement of an optical-based tread depth measuring device and system.

FIG. 5A illustrates an elevation view of an example arrangement of an optical-based tread depth measuring device and system.

FIG. 5B illustrates a sectional view of an example arrangement of an optical-based tread depth measuring device and system.

FIG. 6 illustrates an elevation view of an example arrangement of an optical-based tread depth measuring device and system.

FIG. 7A illustrates a perspective view of an example arrangement of a tire.

FIG. 7B illustrates a perspective view of an example arrangement of a tire.

FIG. 7C illustrates a perspective view of an example arrangement of a tire.

FIG. 8 illustrates a diagram of an optical-based tread depth measuring method.

### DETAILED DESCRIPTION

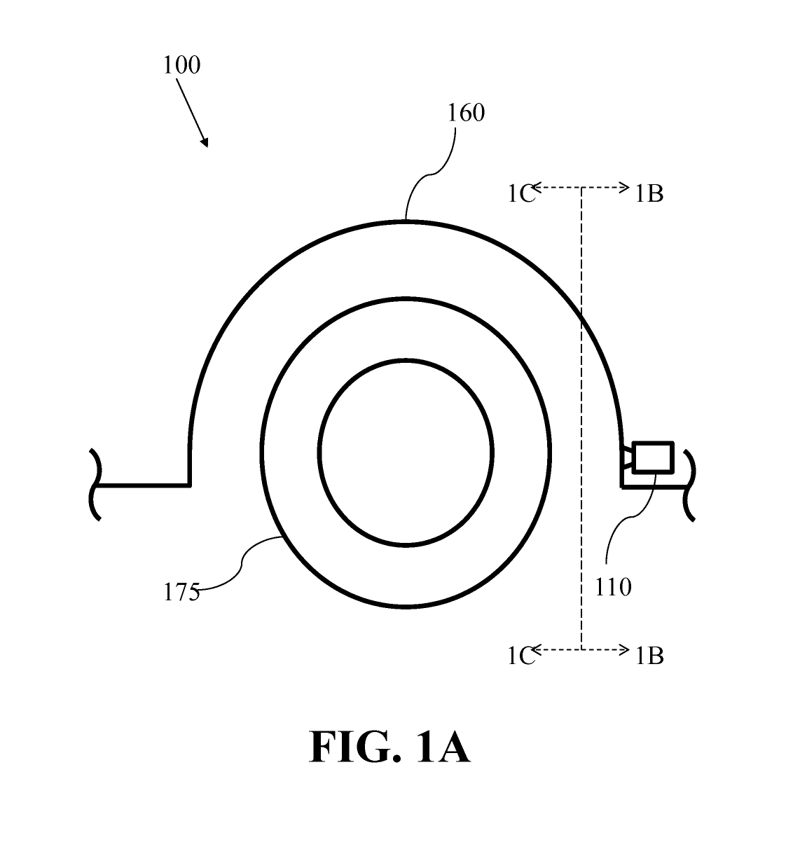

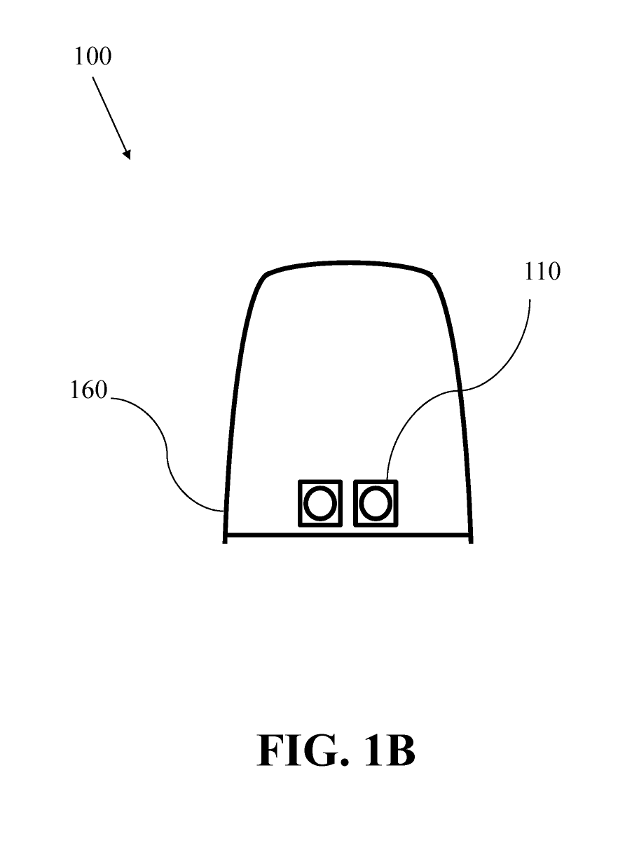

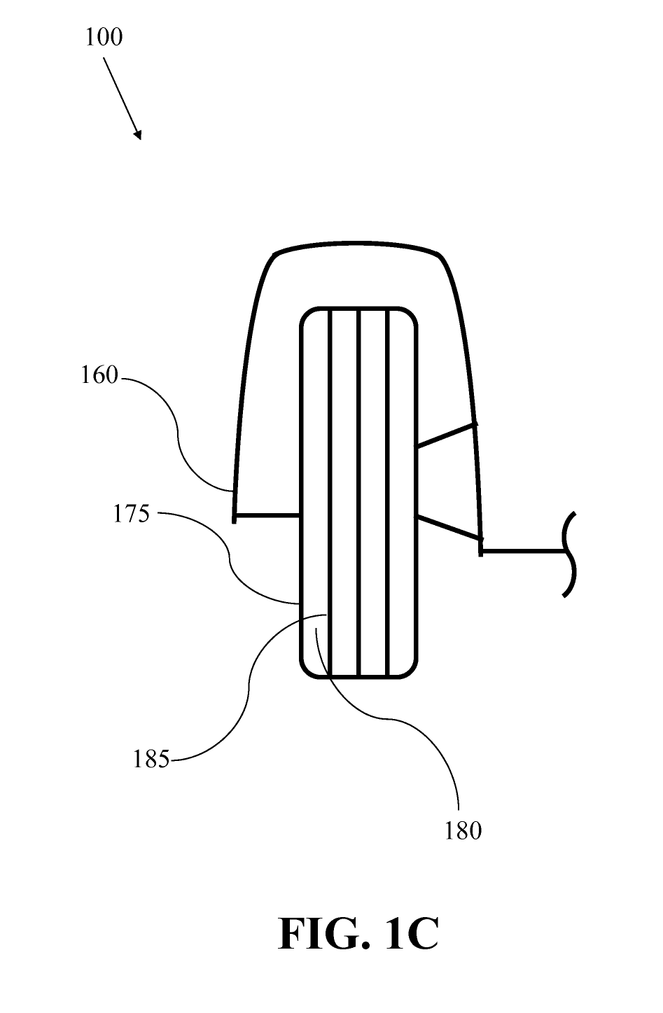

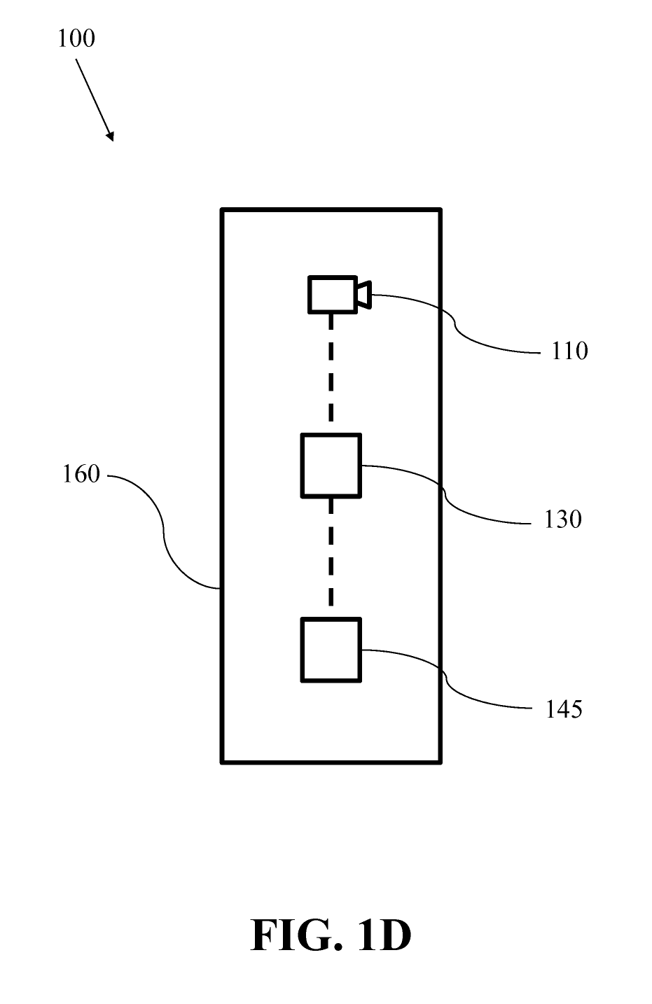

With reference to FIGS. 1A-1D, an optical-based tread depth measuring device 100 may be installed on a vehicle 160. Vehicle 160 may be a road vehicle, such as a passenger car, a tractor-trailer, a bus, and the like. Vehicle 160 may be an off-the-road vehicle. Vehicle 160 may be an agricultural vehicle. Vehicle 160 may be any vehicle with at least one tire 175. Tread depth measuring device 100 may be a system having one or more components configured to optically measure the tread depth of tire 175. Tire 175 may be a pneumatic tire. Tire 175 may be a non-pneumatic tire. Tire 175 may be a non-directional tire, wherein tire 175 is configured to be mounted on a vehicle without a specified forward rolling direction. Tire 175 may be a uni-directional tire, wherein tire 175 is configured to be mounted on a vehicle with a specified forward rolling direction.

FIGS. 1A-1D collectively illustrate an example arrangement of optical-based tread depth measuring device and system 100. FIG. 1A is an elevation view of a tread depth measuring device and system 100. FIG. 1B is a sectional view of tread depth measuring device and system 100. FIG. 1C is a sectional view of tread depth measuring device and system 100. FIG. 1D is a schematic of tread depth measuring device and system 100. Tread depth measuring device and system 100 may have at least one camera 110. Camera 110 may be at least one of a variety of cameras, such as a digital camera, a video camera, a thermographic camera, an ultraviolet camera, a radiographic camera, and the like. Camera 110 may be operatively connected to vehicle 160 near tire 175. Camera 110 may be operatively connected to vehicle 160 by at least one of a bolt, a screw, a nut, a bracket, a hook, a weld, a magnet, an adhesive, and the like. Camera 110 may be operatively connected to vehicle 160 such that camera 110 maintains an unobstructed line of sight to tire 175. Camera 110 may be operatively connected to vehicle 160 at any location on the vehicle that provides an unobstructed line of sight to tire 175, such as a wheel well, a wheel arch, an inner fender, and the like. Camera 110 may be operatively connected to vehicle 160 such that camera 110 maintains an unobstructed line of sight to tire 175 at any angle relative to tire 175. Camera 110 may be configured to capture images of a tread of tire 175 having at least one high tread portion 180 and at least one low tread portion 185. Camera 110 may be configured to transmit a signal of captured images.

Tread depth measuring device and system 100 may have at least one processor 130. Processor 130 may be operatively connected to camera 110. Processor 130 may be operatively connected to camera 110 by at least one of a wire, a circuit trace, and a wireless transmission. Processor 130 may be operatively connected to vehicle 160. Processor 130 may be operatively connected to vehicle 160 by at least one of a bolt, a screw, a nut, a bracket, a hook, a weld, a magnet, an adhesive, and the like. Processor 130 may be configured to receive a signal from camera 110. Processor 130 may be configured to interpret a signal from camera 110. Processor 130 may interpret a signal from camera 110 by comparing at least two images of high tread portion 180 and low tread portion 185 to determine a tread depth measurement.

Tire tread depth measuring system 100 may have two cameras 110. Having two cameras may allow processor 130 to utilize principles of stereo vision to determine the tread depth measurement of tire 175. Stereo vision may allow the same feature of tire 175, such as high tread portion 180 or low tread portion 185, to be identified by both cameras 110. By identifying the location of the same feature of tire 175 in the frame of both cameras 110, a line may be defined from each camera 110 to the feature along a known axis. The intersection of each of the two lines may be mathematically calculated by processor 130. A calibration process may be performed by processor 130 upon at least one of an installation, an initiation, a configuration, and the like, of tread depth measuring device and system 100, so that both the distance between, and the relative orientation of, cameras 110 may be known. The intersection of the two lines may occur only at a single fixed distance away from cameras 110. Processor 130 subtracting the difference between the single fixed distance to high tread portion 180 and the single fixed distance to low tread portion 185 may define the tread depth of tire 175. Processor 130 may be configured to transmit a signal of tire tread depth measurements.

Tread depth measuring system 100 may include an onboard computer 145. Onboard computer 145 may be operatively connected to vehicle 160. Onboard computer 145 may be operatively connected to vehicle 160 by at least one of a bolt, a screw, a nut, a bracket, a hook, a weld, a magnet, an adhesive, and the like. Onboard computer 145 may be a vehicle 160's onboard computer. Onboard computer 145 may be operatively interconnected with at least one of camera 110 and processor 130. Onboard computer 145 may be operatively interconnected with at least one of camera 110 and processor 130 by at least one of a wire, a circuit trace, and a wireless transmission. Onboard computer 145 may be configured to receive a signal from processor 130. Onboard computer 145 may be configured to monitor the tread depth measurement and at least one of: store the tread depth measurement as data, transmit the tread depth measurement to a display device, transmit a message or warning to a vehicle operator, and modify vehicle 160's operating conditions.

Tread depth measuring system 100 may have at least one wireless communication device (not shown). The wireless communication device may be one of a wireless transmitter (not shown), a wireless receiver (not shown), and a wireless transceiver (not shown). The wireless communication devices may be discrete devices operatively interconnected with at least one of camera 110, processor 130, and onboard computer 145. These wireless devices may be integrated into at least one of camera 110, processor 130, and an onboard computer 145.

It is contemplated that at least one of the functions and the structures of camera 110, processor 130, and onboard computer 145 may be either discrete or integrated relative to each other. For example, camera 110 and processor 130 may be separate components in both function and structure. However, camera 110 and processor 130 may be integrated such that a single component integrates at least one of the function and the structure of camera 110 and processor 130. In another example, processor 130 and onboard computer 145 may be separate components in both function and structure. However, processor 130 and onboard computer 145 may be integrated such that a single component integrates at least one of the function and the structure of processor 130 and onboard computer 145.

Tread depth measuring device and system 100 may be configured to measure tread depth while the vehicle is either stationary or moving. Tread depth measuring device and system 100 may be configured to at least one of: measure tread depth intermittently, measure tread depth continuously, be operated manually by a vehicle operator, and be operated automatically by at least one of camera 110, processor 130, and onboard computer 145. Tread depth measuring device and system 100 may be configured to measure tread depth intermittently according to a predetermined schedule based on at least one of: driving time of tire on vehicle and mileage of tire on vehicle. The predetermined schedule may be constant. The predetermined schedule may vary based upon at least one of: road conditions, season of year, age of vehicle, and total mileage of vehicle.

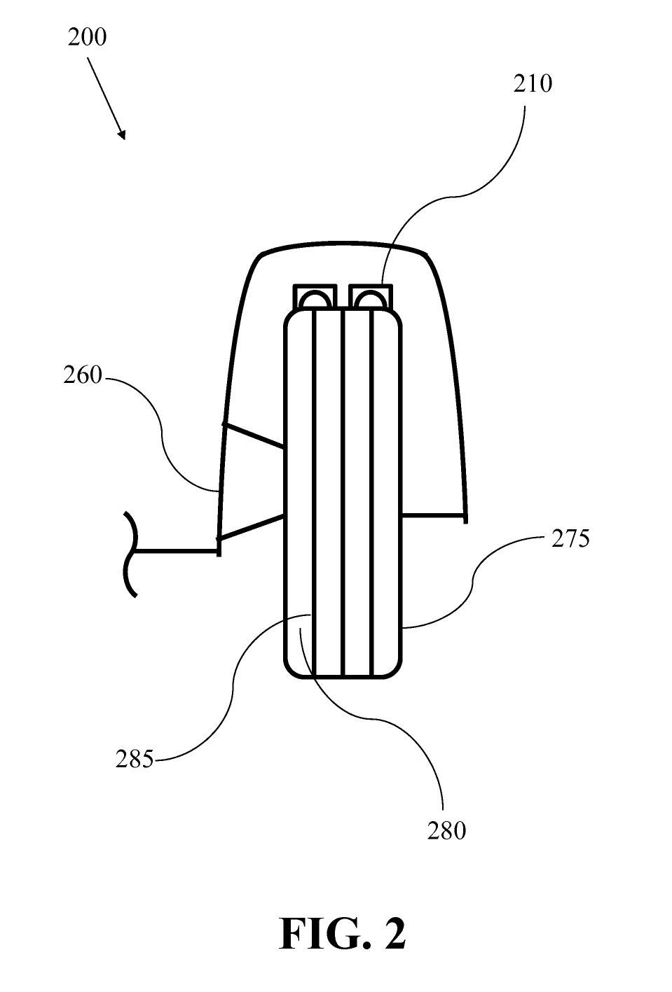

FIG. 2 illustrates an example arrangement of an optical-based tread depth measuring device and system 200. Tire tread depth measuring device and system 200 may have at least one camera 210. Camera 210 may be operatively connected to a vehicle 260 such that camera 210 maintains an unobstructed line of sight to a tire 275 at a point on tire 275 that is radially tangent to the circumference of tire 275 relative to the position of camera 210. Tire 275 may have at least one high tread portion 280 and at least one low tread portion 285. High tread portion 280 may be oriented on the ground contact patch of tire 275. High tread portion 280 may be oriented on the shoulder portion of tire 275. High tread portion 280 may be oriented on the crown of tire 275. Low tread portion 285 may be oriented on the ground contact patch of tire 275. Low tread portion 285 may be oriented on the shoulder portion of tire 275. Low tread portion 285 may be oriented on the crown of tire 275. Low tread portion 285 may be a straight, circumferential groove (not shown), which may facilitate the processor's (not shown) recognition of low tread portion 285 when camera 210 is operatively connected to vehicle 260 such that camera 210 maintains an unobstructed line of sight to tire 275 at a point on tire 275 that is tangent to the circumference of tire 275 relative to the position of camera 210. Low tread portion 285 may be a circumferential groove (not shown). Low tread portion 285 may be a groove base. Low tread portion 285 may be a circumferential groove base. Low tread portion 285 may be an axial groove base. Low tread portion 285 may be a notch base. Low tread portion 285 may be a sipe base.

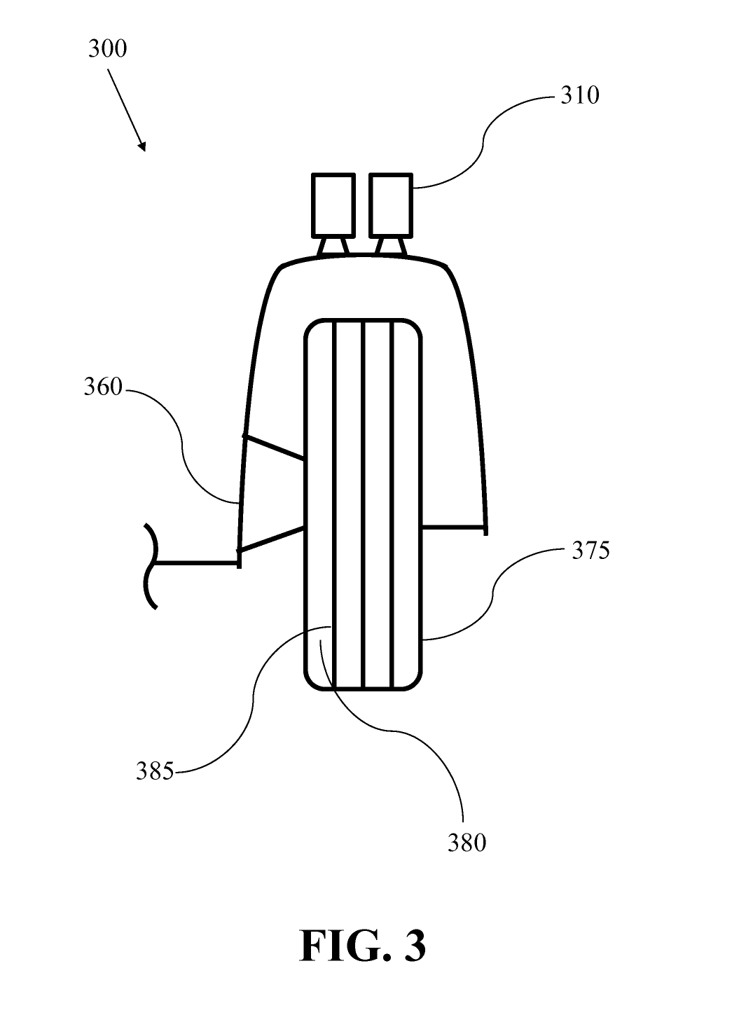

FIG. 3 illustrates an example arrangement of an optical-based tread depth measuring device and system 300. Tire tread depth measuring device and system 300 may have at least one camera 310. Camera 310 may be operatively connected to a vehicle 360 such that camera 310 maintains an unobstructed line of sight to a tire 375 at an angle relative to tire 375 that is radially orthogonal to the ground contact patch of tire 375. Camera 310 may be operatively connected to vehicle 360 such that camera 310 maintains an unobstructed line of sight to tire 375 at any radial angle relative to tire 375. Tire 375 may have at least one high tread portion 380 and at least one low tread portion 385. High tread portion 380 may be oriented on the ground contact patch of tire 375. High tread portion 380 may be oriented on the shoulder portion of tire 375. High tread portion 380 may be oriented on the crown portion of tire 375. Low tread portion 385 may be oriented on the ground contact patch of tire 375. Low tread portion 385 may be oriented on the shoulder portion of tire 375. Low tread portion 385 may be oriented on the crown of tire 375.

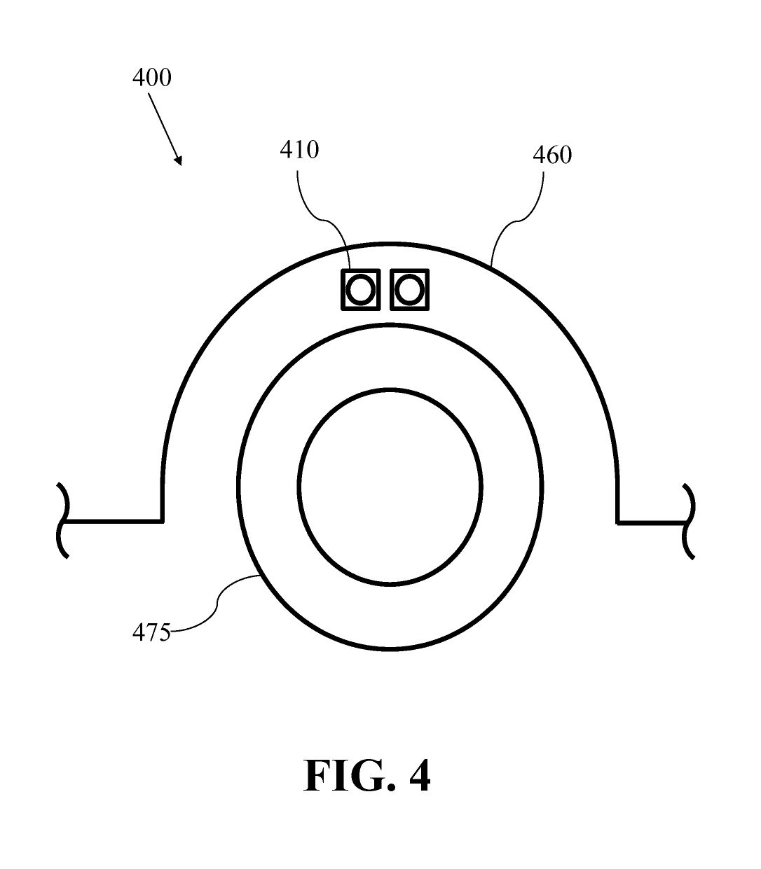

FIG. 4 illustrates an example arrangement of an optical-based tread depth measuring device and system 400. Tire tread depth measuring device and system 400 may have at least one camera 410. Camera 410 may be operatively connected to a vehicle 460 such that camera 410 maintains an unobstructed line of sight to a tire 475 at an angle relative to tire 475 that is axially orthogonal to a shoulder portion of tire 475. Camera 410 may be operatively connected to vehicle 460 such that camera 410 maintains an unobstructed line of sight to tire 475 at any axial angle relative to tire 475. Tire 475 may have at least one high tread portion (not shown) and at least one low tread portion (not shown). The high tread portion may be oriented on the ground contact patch of tire 475. The high tread portion may be oriented on the shoulder portion of tire 475. The high tread portion may be oriented on the crown of tire 475. The low tread portion may be oriented on the ground contact patch of tire 475. The low tread portion may be oriented on the shoulder portion of tire 475. The low tread portion may be oriented on the crown of tire 475.

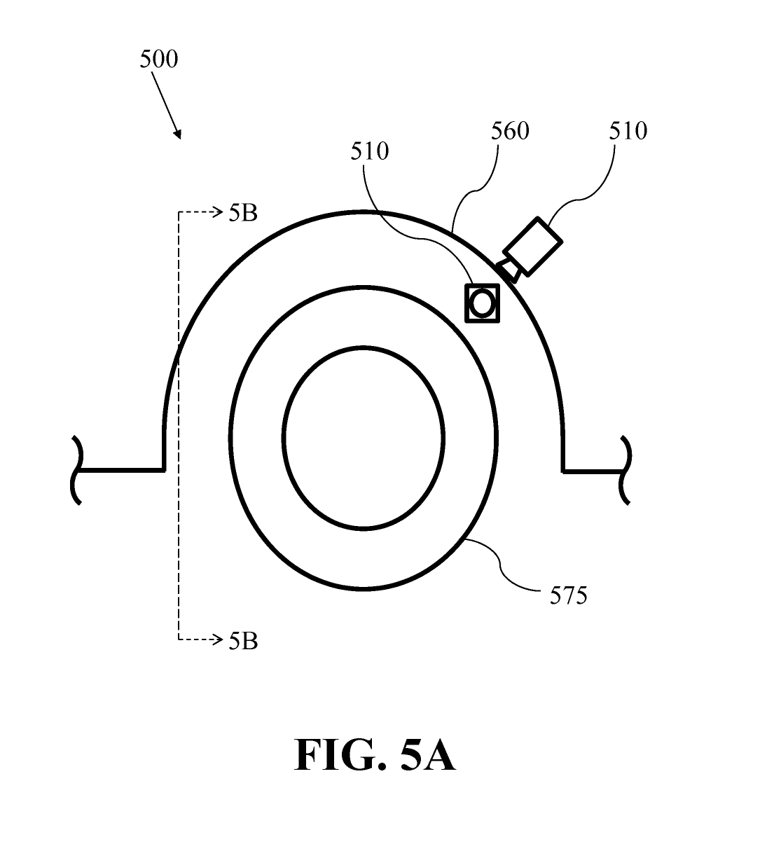

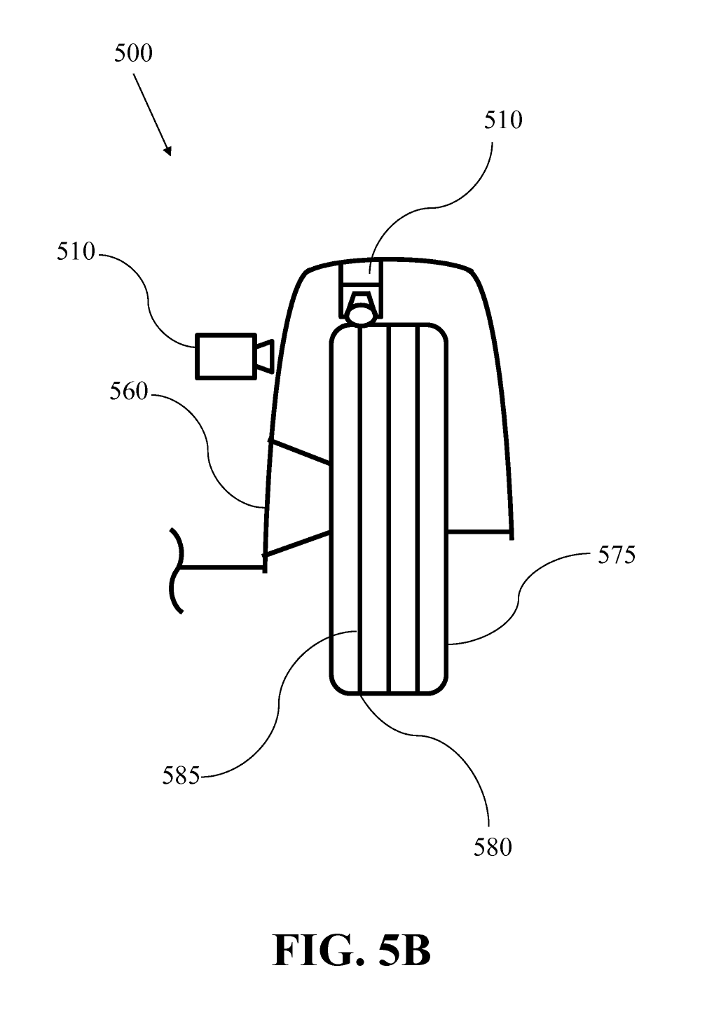

FIGS. 5A-5B collectively illustrate an example arrangement of an optical-based tread depth measuring device and system 500. FIG. 5A illustrates an elevation view of an example arrangement of an optical-based tread depth measuring device and system 500. FIG. 5B illustrates a sectional view of an example arrangement of an optical-based tread depth measuring device and system 500. Tire tread depth measuring device and system 500 may have at least one camera 510. Camera 510 may be operatively connected to a vehicle 560 such that camera 510 maintains an unobstructed line of sight to a tire 575 at an angle relative to tire 575 that is radially orthogonal to the ground contact patch of tire 575. Camera 510 may be operatively connected to vehicle 560 such that camera 510 maintains an unobstructed line of sight to tire 575 at a point on tire 575 that is radially tangent to the circumference of tire 575 relative to the position of camera 510. Camera 510 may be operatively connected to vehicle 560 such that camera 510 maintains an unobstructed line of sight to tire 575 at any radial angle relative to tire 575. Camera 510 may be operatively connected to vehicle 560 such that camera 510 maintains an unobstructed line of sight to tire 575 at an angle relative to tire 575 that is axially orthogonal to a shoulder portion of tire 575. Camera 510 may be operatively connected to vehicle 560 such that camera 510 maintains an unobstructed line of sight to tire 575 at any axial angle relative to tire 575. Tire 575 may have at least one high tread portion 580 and at least one low tread portion 585. High tread portion 580 may be oriented on the ground contact patch of tire 575. High tread portion 580 may be oriented on the shoulder portion of tire 575. High tread portion 580 may be oriented on the crown of tire 575. Low tread portion 585 may be oriented on the ground contact patch of tire 575. Low tread portion 585 may be oriented on the shoulder portion of tire 575. Low tread portion 585 may be oriented on the crown of tire 575.

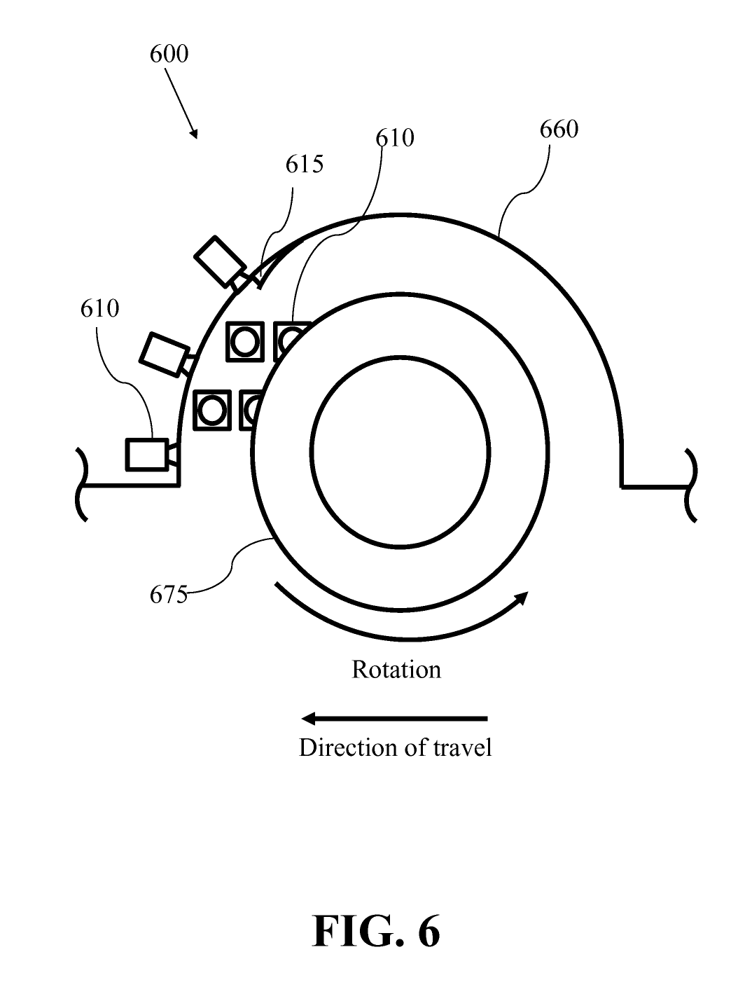

FIG. 6 illustrates an example arrangement of an optical-based tread depth measuring device and system 600. Tread depth measuring device and system 600 may have at least one camera 610. Camera 610 may be operatively connected to a vehicle 660 such that camera 610 maintains an unobstructed line of sight to a tire 675 at any angle relative to tire 675. When vehicle 660 travels along a surface, tire 675 may lift up from the road surface a variety of road contaminants, such as dirt, sand, stones, pebbles, mud, water, and the like. Road contaminants may be deposited on vehicle 660 in the area around tire 675, such as on wheel wells, wheel arches, inner fenders, and the like. Due to camera 610's close proximity to tire 675, road contaminants may be deposited on camera 610, resulting in a partially or fully obstructed line of sight to tire 675. Thus, it may be necessary to protect camera 610 from road contaminants.

Tire tread depth measuring system 600 may include a camera protection device 615. Camera protection device 615 may be operatively connected to vehicle 660 such that camera 610 may be protected from road contaminants to sufficiently maintain an unobstructed line of sight to tire 675. Camera protection device 615 may be a shield oriented between camera 610 and tire 675 or any road contaminants. Camera protection device 615 may be a clear polymer shield or clear glass shield oriented between camera 610 and tire 675 or any road contaminants.

Camera protection device 615 may be a cover, door, shutter, and the like oriented between camera 610 and tire 675 or any road contaminants. Camera protection device 615 may be a cover, door, shutter, and the like configured to partially or completely obstruct or seal camera 610 from tire 675 or any road contaminants. Camera protection device 615 may include an electro-mechanical system, which may be in communication with tread depth measuring device or system 600, and may manipulate the cover, door, or shutter upon activation by either a vehicle operator or tread depth measuring device or system 600. Such manipulation may be a rotation, translation, and the like so as to remove the cover, door, or shutter from the line of sight between camera 610 and tire 675. Such manipulation may occur only momentarily for a duration sufficient to allow camera 610 to capture one or more images as required by tread depth measuring device or system 600. When camera 610 is not capturing an image of tire 675, the cover, door, or shutter of camera protection device 615 may remain oriented in a position so as to partially or completely obstruct or seal camera 610 from tire 675 or any road contaminants.

Camera protection device 615 may be a wiper configured to wipe across a shield or a lens of camera 610 prior to use of camera 610, so as to ensure that the shield or lens is clean enough to view tire 675 and measure tread depth.

Camera protection device 615 may be a screen oriented between camera 610 and tire 675 so as to prevent road contaminants from coming into contact with, or obstructing the line of sight of, camera 610.

Camera protection device 615 may be a film oriented over or near camera 610. Camera protection device 615 may be a clear polymer film that may be at least one of: removed, replaced, or repositioned so as to remove from camera 610's line of sight any road contaminants that may have accumulated on the film of camera protection device 615. The film may be operatively connected to a roller at each end, such as with a parchment scroll. Camera protection device 615 may include an electro-mechanical system, which may be in communication with tread depth measuring device or system 600, and may rotate the rollers just prior to capturing an image, so as to present a fresh portion of film to camera 610.

Camera protection device 615 may be at least one of: a fluid, a reservoir, a pressurization device, a hose, a tube, and a nozzle configured to administer a pressurized fluid to a shield or lens of camera 610 so as to remove road contaminants that may have collected on the shield or lens. The fluid of camera protection device 615 may be at least one of: a commercially available automotive windshield washer fluid, water, an ammonia or bleach based solution, or any fluid suitable for removing road contaminants from a shield or a lens. The fluid may be automotive windshield washer fluid from a vehicle's existing onboard supply of automotive windshield washer fluid.

Camera protection device 615 may be a recess into which camera 610 is oriented so as to remove camera 610 from the path of road contaminants while maintaining an unobstructed line of sight to tire 675. Camera protection device 615 may be a substantial recess, such as an elongated tube, through which camera 610 may capture an image of tire 675. Camera 610 may be recessed by a distance. This distance may be any distance capable of removing camera 610 from a path of road contaminants. The distance may be between about 1.0 cm and about 20.0 cm.

Camera protection device 615 may be any number or combination of devices, such as, without limitation, those devices described above, that may aid in maintaining an unobstructed line of sight between camera 610 and tire 675.

Furthermore, camera 610 may be operatively connected to vehicle 660 at a position that receives a minimal amount of road contaminant deposits. Such a location may include the portion of vehicle 660 near tire 675 that is nearest to the direction of travel. FIG. 6 illustrates merely a few examples of such locations.

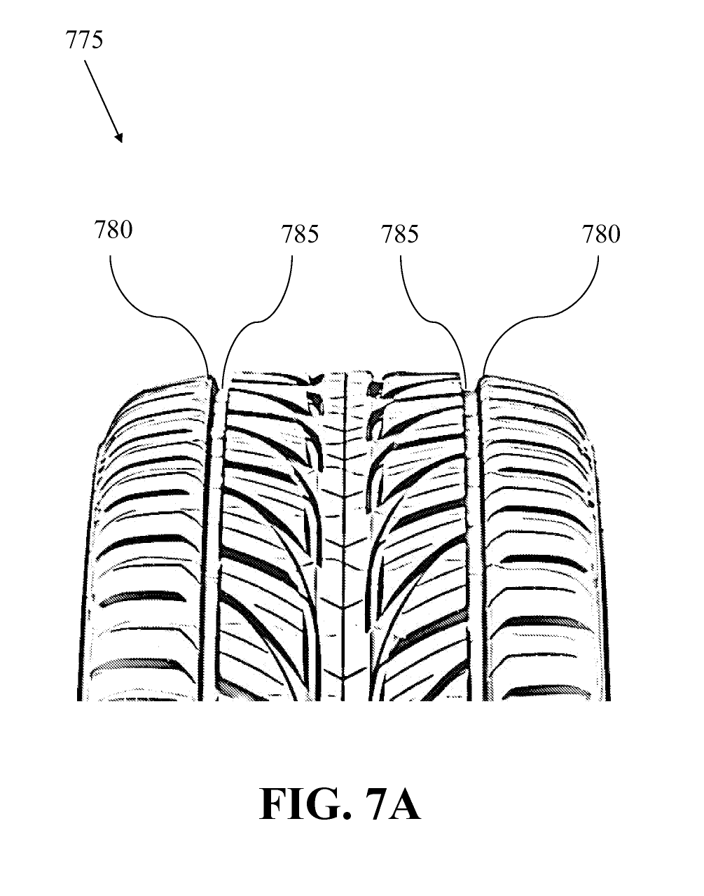

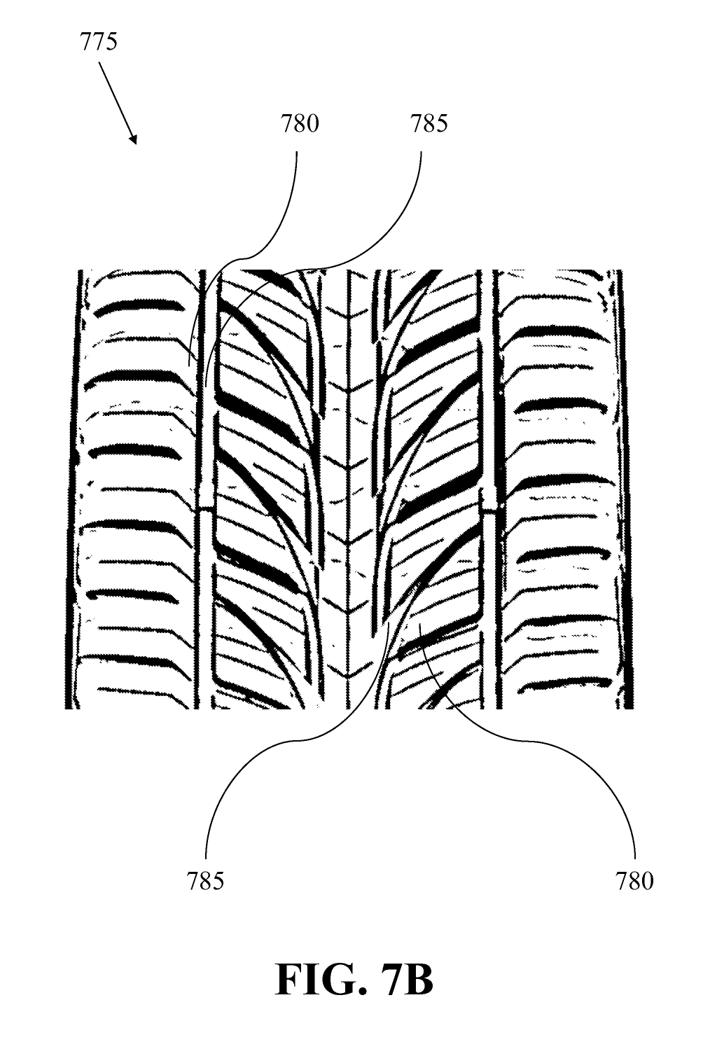

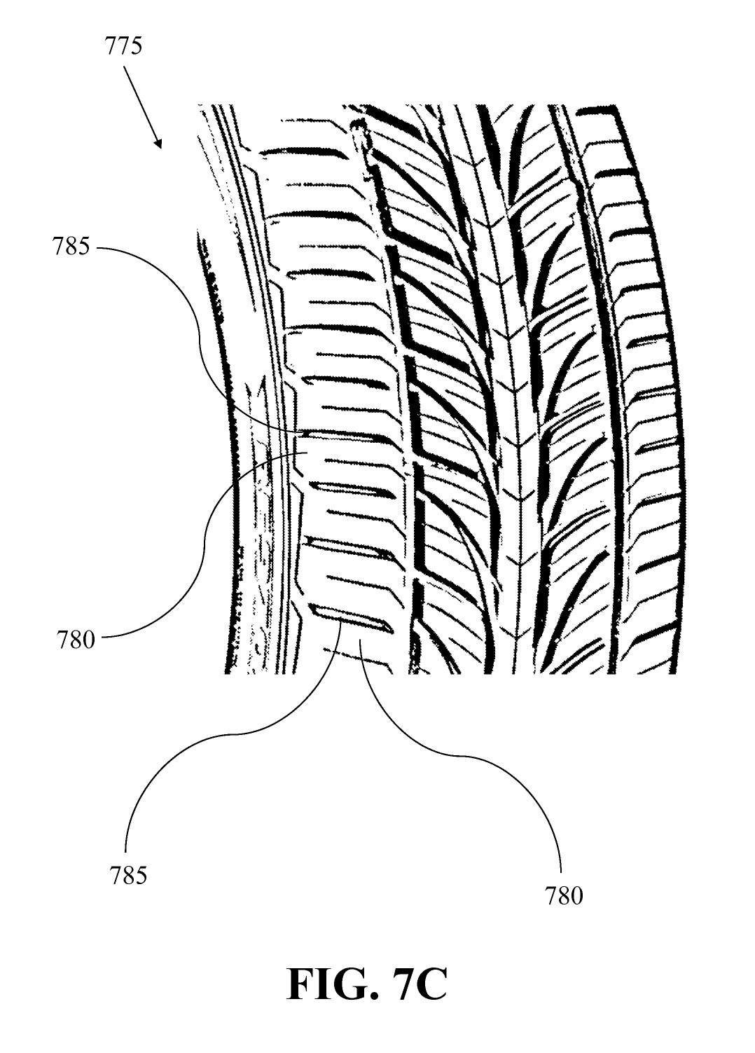

With reference to FIGS. 7A-7C, a tire 775 may include a tread having at least one high tread portion 780. High tread portion 780 may be a land portion, or more generally, high tread portion 780 may be the radially outermost portion of the tread. High tread portion 780 may be oriented in a ground contact patch of tire 775. High tread portion 780 may be oriented in a shoulder portion of tire 775. High tread portion 780 may be oriented in a crown of tire 775.

Tire 775 may include a tread having at least one low tread portion 785. Low tread portion 785 may be a groove, or more specifically, the radially innermost portion of a groove adjacent to high tread portion 780. Low tread portion 785 may be a circumferential groove. Low tread portion 785 may be a groove base. Low tread portion 785 may be a circumferential groove base. Low tread portion 785 may be an axial groove base. Low tread portion 785 may be a notch base. Low tread portion 785 may be a sipe base. Low tread portion 785 may be oriented in the ground contact patch of tire 775. Low tread portion 785 may be oriented in the shoulder portion of tire 775. Low tread portion 785 may be oriented in crown of tire 775. As tire 775 rolls along a surface, high tread portion 780 may be abraded away such that high tread portion 780 erodes radially inward toward low tread portion 785. The radial distance between high tread portion 780 and low tread portion 785 may be referred to as the “tread depth.”

FIGS. 7A-7C collectively illustrate a tread portion of a tire 775. FIG. 7A illustrates the tread of tire 775 as may be seen by a camera (not shown) that is positioned on a vehicle (not shown) so as to maintain an unobstructed line of sight to a point on tire 775 that is radially tangent to the circumference of tire 775 relative to the position of the camera. Tire 775 may have at least one high tread portion 780 and at least one low tread portion 785, either of which may be located in at least one of a shoulder portion and a ground contact patch of tire 775. A single camera may capture images of at least one high tread portion 780 and at least one low tread portion 785 when low tread portion 785 is located at the radially innermost point of a straight, circumferential groove as illustrated in FIG. 7A. More than one camera may be needed if tire 775 does not have any straight, circumferential grooves. A processor may potentially identify the optimal tread surface points for determining a tread depth measurement by generating a profile of tire 775 and identifying the largest difference in depth between nearby points, such as high tread portion 780 and low tread portion 785. The camera may be selected with an appropriate resolution for use with a particular line of sight based upon the width of the grooves of tire 775. For example, cameras with higher resolutions may be able to detect narrower grooves than cameras with lower resolutions.

FIG. 7B illustrates the tread of tire 775 as seen by a camera that is positioned on the vehicle so as to maintain an unobstructed line of sight to tire 775 at an angle relative to tire 775 that is radially orthogonal to the ground contact patch of tire 775. The camera may be positioned such that the line of sight from the camera to tire 775 may form any angle relative to tire 775. At least one camera may capture images of at least one high tread portion 780 and at least one low tread portion 785. Two cameras configured for stereo vision may capture images of at least one high tread portion 780 and at least one low tread portion 785. The processor may potentially identify the optimal tread surface points for determining a tread depth measurement by identifying the largest difference in depth between nearby points, such as high tread portion 780 and low tread portion 785.

FIG. 7C illustrates the tread of tire 775 as seen by a camera that is positioned on the vehicle so as to maintain an unobstructed line of sight to both the shoulder portion and the ground contact patch of tire 775. Tire 775 may have at least one high tread portion 780 and at least one low tread portion 785. The camera may be positioned such that the line of sight from the camera to tire 775 may form any angle relative to tire 775. At least one camera may capture images of at least one high tread portion 780 and at least one low tread portion 785. Two cameras configured for stereo vision may capture images of at least one high tread portion 780 and at least one low tread portion 785. The processor may potentially identify the optimal tread surface points for determining a tread depth measurement by identifying the largest difference in depth between nearby points, such as high tread portion 780 and low tread portion 785.

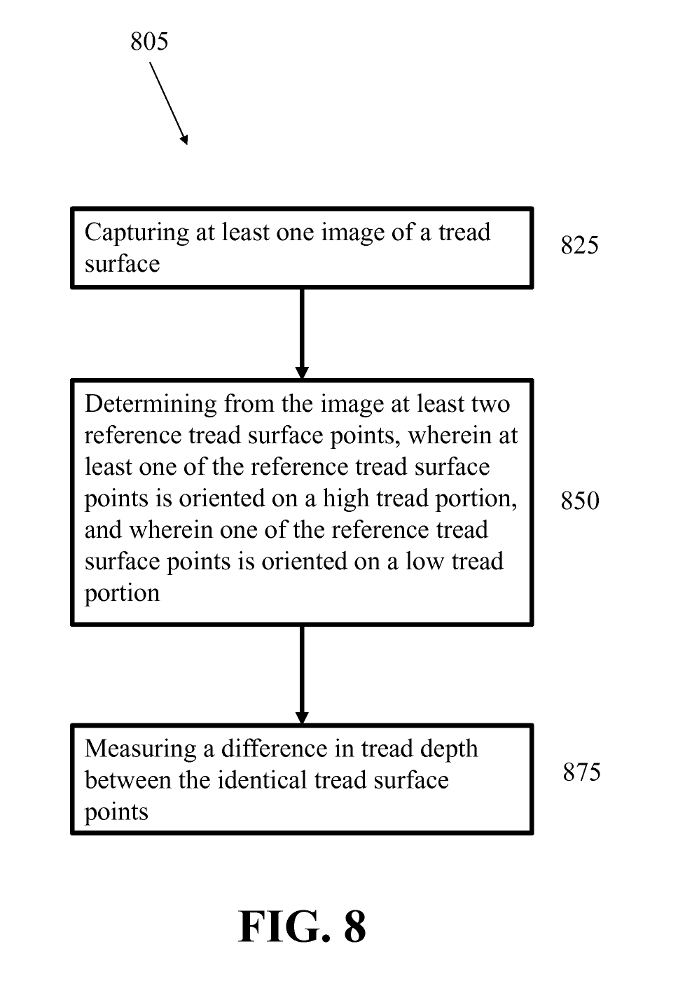

FIG. 8 illustrates a diagram of an optical-based tread depth measuring method 805. Tread depth measuring method 805 may be at least one of: initiated, controlled, monitored, or terminated; either manually by a vehicle operator, or automatically by at least one of a camera, a processor, and an onboard computer. Tread depth measuring method 805 may include capturing at least one image of a tread surface (step 825). The tread surface image may be captured by at least one camera and may include at least one high tread portion and at least one low tread portion. The image may be captured while a vehicle is either stationary or moving. The image may be transmitted from the camera to a processor. Tread depth measuring method 805 may include determining from the image at least two reference tread surface points (step 850). At least one of the reference tread surface points may be oriented on a high tread portion. At least one of the reference tread surface points may be oriented on a low tread portion. Tread depth measuring method 805 may include measuring a difference in tread depth between the reference tread surface points (step 875). This difference in tread depth may represent the tread depth measurement. The processor may determine at least one of the reference tread surface points and the tread depth measurement. The processor may transmit the tread depth measurement to the onboard computer. The onboard computer may store the tread depth measurement as data, transmit the tread depth measurement to a display device, transmit a message or warning to a vehicle operator, modify vehicle's operating conditions, and the like.

It is contemplated that any of the optical-based tread depth measuring configurations and orientations disclosed herein with respect to any particular figure may likewise be applied in an alternative arrangement to any other figure. That is, the tread depth measuring configurations and orientations illustrated in each particular figure are not intended to be limiting, and it is contemplated that any configuration and orientation illustrated or disclosed could be interchanged with another configuration and orientation.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Gamer, A Dictionary of Modem Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in the relevant industry. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A tire tread depth measuring device, comprising:
at least one camera configured to capture images of a tire tread surface; and
at least one processor operatively connected to the camera,
wherein the processor is configured to receive, interpret, and transmit a signal from the camera and determine a depth measurement of the tire tread surface, and
wherein the at least one of the camera and the processor is operative connected to a vehicle.

2. The tire tread depth measuring device of claim 1, wherein the camera is at least one of: a digital camera, a video camera, a thermographic camera, an ultraviolet camera, and a radiographic camera.

3. The tire tread depth measuring device of claim 1, wherein the at least one camera includes two cameras configured to capture stereographic images.

4. The tire tread depth measuring device of claim 1, further comprising at least one of: a wireless transmitter, a wireless receiver, and a wireless transceiver.

5. The tire tread depth measuring device of claim 1, wherein the tread depth measuring device is configured to measure tread depth while the vehicle is either stationary or moving.

6. A tire tread depth measuring system, comprising:
a vehicle having an onboard computer;
at least one tire having a tread surface, wherein the at least one tire is mounted to the vehicle;
at least one camera, wherein the at least one camera is oriented to have an unobstructed line of sight to the tire tread surface; and
at least one processor operatively connected to at least one of the camera and the onboard computer,
wherein the processor is configured to receive and interpret a signal from the camera, determine a depth measurement of the tread surface, and transmit the depth measurement to the onboard computer.

7. The tire tread depth measuring system of claim 6, further comprising a camera protection device,
wherein the camera protection device is configured to at least one of clean and protect the camera,
wherein the camera protection device comprises at least one of: a shield, a cover, a wiper, a screen, a film, a fluid, a reservoir, a pressurization device, a nozzle, a tube, a recess, a shutter, and a door.

8. The tire tread depth measuring system of claim 6, wherein the camera is at least one of: a digital camera, a video camera, a thermographic camera, an ultraviolet camera, and a radiographic camera.

9. The tire tread depth measuring system of claim 6, wherein the at least one camera includes two cameras configured to capture stereographic images.

10. The tire tread depth measuring system of claim 6, further comprising at least one of: a wireless transmitter, a wireless receiver, and a wireless transceiver.

11. The tire tread depth measuring system of claim 6, wherein at least one of the camera and the processor are operatively connected to a vehicle.

12. A tire tread depth measuring method, comprising:
capturing with at least one camera at least one image of a tread surface;
determining from the image at least two reference tread surface points,
wherein at least one of the reference tread surface points is oriented on a high tread portion, and
wherein at least one of the reference tread surface points is oriented on a low tread portion; and
measuring a difference in tread depth between the reference tread surface points,
wherein at least one of the step of determining two reference points and the step of measuring a difference in tread depth is performed by a processor, and
wherein the measured difference in tread depth is transmitted to a vehicle having an onboard computer.

13. The tire tread depth measuring method of claim 12, wherein the method is performed on a stationary vehicle.

14. The tire tread depth measuring method of claim 12, wherein the method is performed on a moving vehicle.

15. The tire tread depth measuring method of claim 16, wherein the method is initiated automatically by at least one of: the camera, the processor, and the vehicle having an onboard computer.

16. The tire tread depth measuring device of claim 1, wherein the processor and the camera are operatively interconnected by at least one of: a wire, a circuit trace, and a wireless transmission.

17. The tire tread depth measuring device of claim 1, wherein at least one of the camera and the processor is operatively connected to the vehicle by at least one of: a bolt, a screw, a nut, a bracket, a hook, a weld, a magnet, and an adhesive.

18. The tire tread depth measuring system of claim 6, wherein at least one of the camera, the processor, and the onboard computer are operatively interconnected by at least one of: a wire, a circuit trace, and a wireless transmission.

19. The tire tread depth measuring system of claim 11, wherein at least one of the camera and the processor are operatively connected to the vehicle by at least one of: a bolt, a screw, a nut, a bracket, a hook, a weld, a magnet, and an adhesive.

20. The tire tread depth measuring method of claim 12, wherein the method is initiated manually by a vehicle operator.
